(19) United States
(12) Patent Application Publication
(10) Pub. No.: US 2015/0029371 A1
(43) Pub. Date: Jan. 29, 2015

(54) SOLID-STATE IMAGING DEVICE

(71) Applicant: Kabushiki Kaisha Toshiba, Minato-ku (JP)

(72) Inventor: Kazuki HIZU, Ota-ku (JP)

(73) Assignee: Kabushiki Kaisha Toshiba, Minato-ku (JP)

(21) Appl. No.: 14/150,032

(22) Filed: Jan. 8, 2014

(30) Foreign Application Priority Data
Jul. 25, 2013 (JP) 2013-154446

(51) Int. Cl. H04N 5/374

(52) U.S. Cl. CPC H04N 5/374
USPC 348/308

(57) ABSTRACT

According to one embodiment, a pixel array unit, a column ADC circuit, and a calculation circuit are provided. In the pixel array unit, pixels accumulating photoelectric converted charges are arranged in a matrix form. The column ADC circuit performs count operation based on phase relationship between a first clock and a second clock of which cycle is different from that of the first clock by looking up a comparison result between a reference voltage and a pixel signal that is read from the pixel. The calculation circuit calculates an AD conversion value of the pixel signal on the basis of a count result of the column ADC circuit.

### CROSS-REFERENCE TO RELATED APPLICATIONS

This application is based upon and claims the benefit of priority from Japanese Patent Application No. 2013-154446, filed on Jul. 25, 2013; the entire contents of which are incorporated herein by reference.

### FIELD

Embodiments described herein relate generally to a solid-state imaging device.

### BACKGROUND

In the solid-state imaging device, a method for performing count operation in accordance with a reference clock is used to convert a signal which is read from a pixel into a digital value. It used to be necessary to increase the frequency of the reference clock in order to increase the resolution while maintaining the reading speed of the signal from the solid-state imaging device.

### BRIEF DESCRIPTION OF THE DRAWINGS

FIG. 1 is a block diagram illustrating a schematic configuration of a solid-state imaging device according to a first embodiment;

FIG. 2 is a circuit diagram illustrating an example of configuration of a pixel of the solid-state imaging device of FIG. 1;

FIG. 3 is a circuit diagram illustrating an example of configuration of a reference voltage generation circuit and column ADC circuit of FIG. 1;

FIG. 4 is a block diagram illustrating an example of configuration of a time digital conversion device of FIG. 3;

FIG. 5 is a timing chart illustrating a voltage waveform of each unit during reading operation of the pixel of FIG. 1;

FIG. 6 is a timing chart illustrating operation of the time digital conversion device of FIG. 4;

FIG. 7 is a circuit diagram illustrating an example of configuration of an activation circuit 22, a vernier oscillator 23, and mask circuits 24, 26 of FIG. 4;

FIG. 8 is a circuit diagram illustrating an example of configuration of delay devices H1 to H5 of FIG. 7;

FIG. 9 is a circuit diagram illustrating an example of configuration of ripple counters 25, 27 of FIG. 4;

FIG. 10 is a timing chart illustrating operation of the ripple counters 25, 27 of FIG. 9;

FIG. 11 is a circuit diagram illustrating an example of configuration of flip-flops F1 to F3 of FIG. 9;

FIG. 12 is a block diagram illustrating an example of configuration of a delay time control circuit of FIG. 1;

FIG. 13 is a timing chart illustrating a voltage waveform of each unit during reading operation of the pixel with a solid-state imaging device according to a second embodiment;

FIG. 14 is a timing chart illustrating operation of a time digital conversion device in the solid-state imaging device according to the second embodiment; and

FIG. 15 is a block diagram illustrating a schematic configuration of a digital camera to which a solid-state imaging device according to a third embodiment is applied.

### DETAILED DESCRIPTION

In general, according to one embodiment, a pixel array unit, a column ADC circuit, and a calculation circuit are provided. In the pixel array unit, pixels accumulating photoelectric converted charges are arranged in a matrix form. The column ADC circuit performs count operation based on phase relationship between a first clock and a second clock of which cycle is different from that of the first clock by looking up a comparison result between a reference voltage and a pixel signal that is read from the pixel. The calculation circuit calculates an AD conversion value of the pixel signal on the basis of a count result of the column ADC circuit.

A solid-state imaging device according to the embodiments will be described in detail with reference to the accompanying drawings. It should be noted that the present invention is not limited by these embodiments.

### First Embodiment

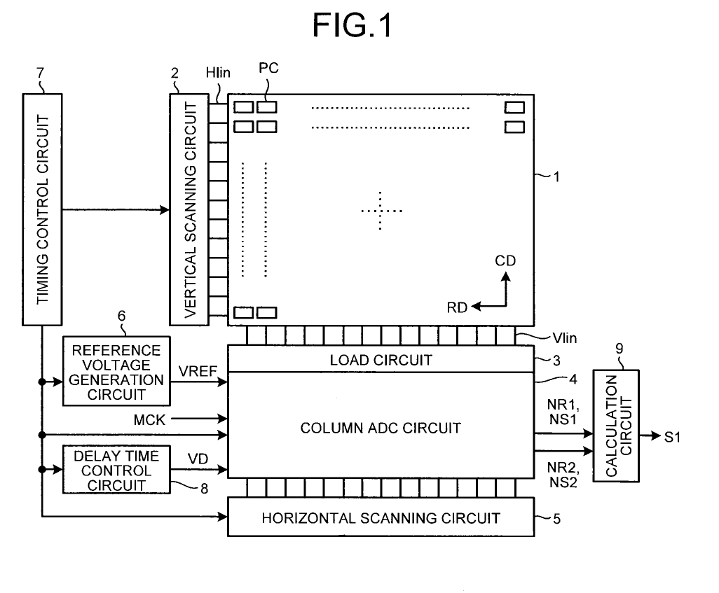

FIG. 1 is a block diagram illustrating a schematic configuration of a solid-state imaging device according to a first embodiment.

In FIG. 1, the solid-state imaging device is provided with a pixel array unit 1. The pixel array unit 1 includes pixels PC accumulating photoelectric converted charges, and the pixels PC are arranged in a matrix form of m (m is a positive integer) rows by n (n is a positive integer) columns in the row direction RD and the column direction CD, respectively. In the pixel array unit 1, horizontal control lines Hlin for performing reading control of the pixels PC are arranged in the row direction RD, and vertical signal lines Vlin for transmitting signals which are read from the pixels PC are arranged in the column direction CD.

The solid-state imaging device includes a vertical scanning circuit 2 scanning pixels PC which is to be read in the vertical direction, a load circuit 3 for reading a pixel signal in each column from a pixel PC to the vertical signal line Vlin by performing source follower operation with the pixel PC, a column ADC circuit 4 for detecting a signal component of each pixel PC for each column with CDS, a horizontal scanning circuit 5 for scanning pixels PC which is to be read in the horizontal direction, a reference voltage generation circuit 6 for outputting a reference voltage VREF to the column ADC circuit 4, and a timing control circuit 7 for controlling timing of reading and accumulation of each pixel PC. The reference voltage VREF may use a ramp wave. In this case, the column ADC circuit 4 refers to a comparison result between the reference voltage VREF and the pixel signal that is read from the pixel PC, thereby performing count operation on the basis of a phase relationship between a reference clock MCK and a vernier clock BCK of which cycle is different from the reference clock MCK. It should be noted that the cycle of the vernier clock BCK is set so that the cycle of the reference clock MCK is divided with variation of the phase difference from the reference clock MCK for each cycle of the vernier clock BCK.

Further, the solid-state imaging device is provided with a calculation circuit 9 for calculating the AD conversion value of the pixel signal on the basis of the count result of the column ADC circuit 4 and the delay time control circuit 8 controlling the cycle of the vernier clock BCK. The delay time control circuit 8 outputs the delay time control voltage VD to the column ADC circuit 4 in order to control the cycle of the vernier clock BCK. In order to simplify the configuration of the calculation circuit 9, the vernier clock BCK is preferably set so that the cycle is longer than the reference clock MCK by ½ⁿ (n is positive integer). In this case, the calculation circuit 9 may be constituted by an n bit shifter and an adder.

The vertical scanning circuit 2 scans the pixels PC in the vertical direction, thereby selecting the pixel PC in the row direction RD. The load circuit 3 performs source follower operation with the pixel PC, whereby reset level and signal level of the pixel signal that is read from the pixel PC is transmitted via the vertical signal line Vlin, and sent to the column ADC circuit 4. The reference voltage generation circuit 6 sets a ramp wave as the reference voltage VREF, which is sent to the column ADC circuit 4. When the reset level of the pixel signal that is read from the pixel PC is sent to the column ADC circuit 4, the count operation of the reference clock MCK is performed from when the level of the ramp wave attains the reset level to when the phase relationship of the reference clock MCK and the vernier clock BCK is inversed, whereby a first count value NR1 at the reset level is calculated. Further, after the phase relationship of the reference clock MCK and the vernier clock BCK is inversed, the count operation of the reference clock MCK is performed, whereby a second count value NR2 at the reset level is calculated. The calculation circuit 9 calculates the AD conversion value at the reset level of the pixel signal on the basis of the first count value NR1 and the second count value NR2.

When the signal level of the pixel signal that is read from the pixel PC is sent to the column ADC circuit 4, the count operation of the reference clock MCK is performed from when the level of the ramp wave attains the signal level to when the phase relationship of the reference clock MCK and the vernier clock BCK is inversed, whereby a first count value NR1 at the signal level is calculated. Further, after the phase relationship of the reference clock MCK and the vernier clock BCK is inversed, the count operation of the reference clock MCK is performed, whereby a second count value NS2 at the signal level is calculated. The calculation circuit 9 calculates the AD conversion value at the signal level of the pixel signal on the basis of the first count value NS1 and the second count value NS2. By calculating the difference of the AD conversion value of the reset level and the AD conversion value of the signal level at that occasion, the signal component of each pixel PC is detected by the CDS, and is output as an output signal S1.

At this occasion, the second count values NR2, NS2 can be used as vernier for the first count values NR1, NS1. More specifically, the first count values NR1, NS1 can be used as the lower bit of the AD conversion value of the pixel signal, and the second count values NR2, NS2 can be used as the upper bit of the AD conversion value of the pixel signal.

Accordingly, the resolution of the AD conversion value of the pixel signal can be increased while suppressing the increase of the frequency of the reference clock MCK. For this reason, the quality of the image capturing image can be improved by suppressing the increase of the power consumption.

Hereinafter, the solid-state imaging device of FIG. 1 will be described in more details.

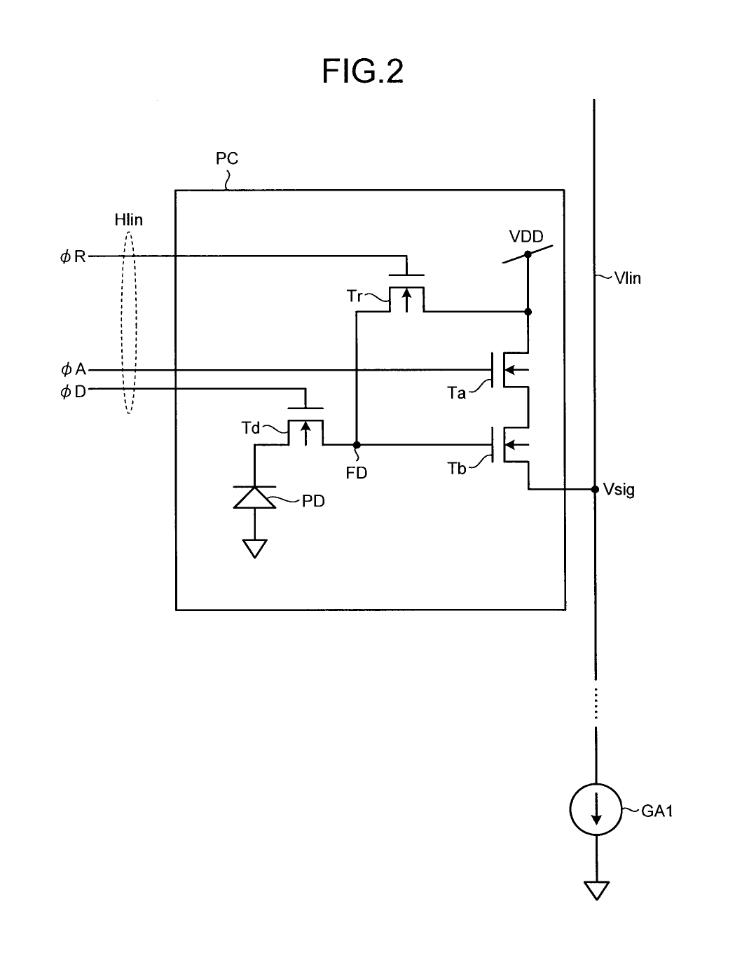

FIG. 2 is a circuit diagram illustrating an example of configuration of a pixel of the solid-state imaging device of FIG. 1.

In FIG. 2, each pixel PC includes a photodiode PD, a row selection transistor Ta, an amplification transistor Tb, a reset transistor Tr, and a reading transistor Td. A floating diffusion FD is formed as a detection node at a connection point of the amplification transistor Tb, the reset transistor Tr, and the reading transistor Td.

In the pixel PC, the source of the reading transistor Td is connected to the photodiode PD, and a reading signal ΦD is input into the gate of the reading transistor Td. The source of the reset transistor Tr is connected to the drain of the reading transistor Td, and a reset signal ΦR is input into the gate of the reset transistor Tr, and the drain of the reset transistor Tr is connected to a power supply potential VDD. A row selection signal ΦA is input into the gate of the row selection transistor Ta, and the drain of the row selection transistor Ta is connected to the power supply potential VDD. The source of the amplification transistor Tb is connected to the vertical signal line Vlin, and the gate of the amplification transistor Tb is connected to the drain of the reading transistor Td, and the drain of the amplification transistor Tb is connected to the source of the row selection transistor Ta. The horizontal control lines Hlin of FIG. 1 can transmit the reading signal ΦD, the reset signal ΦR, and the row selection signal ΦA to the pixels PC for each row. The load circuit 3 of FIG. 1 is provided with a constant current source GA1 for each column, and the constant current source GA1 is connected to the vertical signal line Vlin.

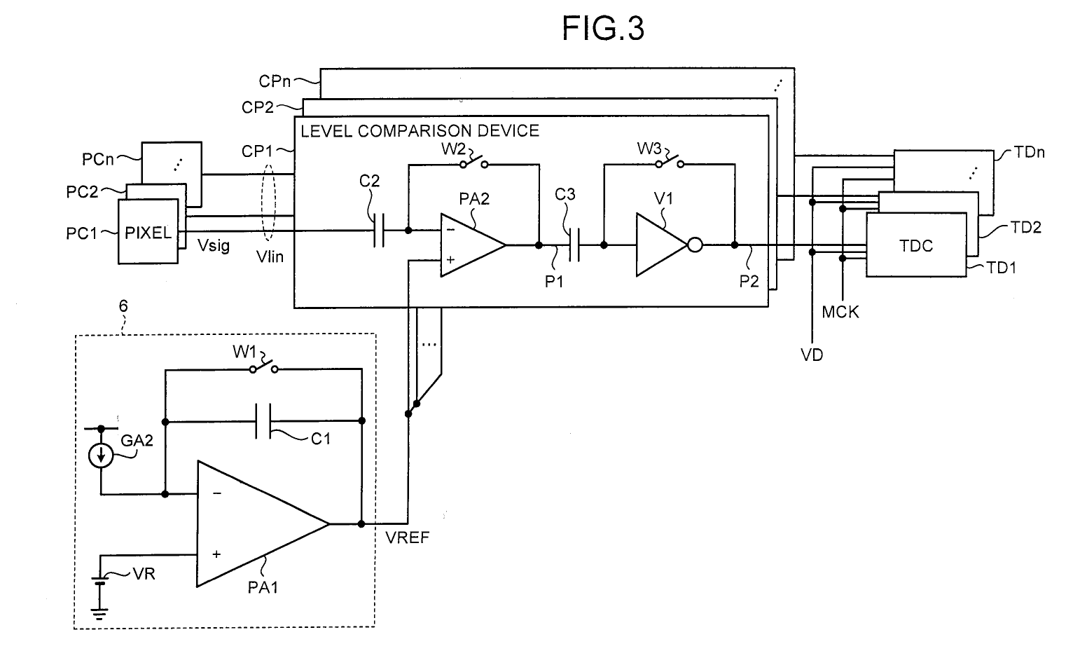

FIG. 3 is a circuit diagram illustrating an example of configuration of a reference voltage generation circuit and column ADC circuit of FIG. 1.

In FIG. 3, the reference voltage generation circuit 6 includes an operational amplifier PA1, a capacitor C1, a switch W1, a constant current source GA2, and a reference power supply VR.

The capacitor C1 is connected between the inverse input terminal and the output terminal of the operational amplifier PA1. The switch W1 is connected in parallel with the capacitor C1. A constant current source GA2 is connected to the inverse input terminal of the operational amplifier PA1. The non-inverse input terminal of the operational amplifier PA1 is connected to the reference power supply VR.

When the switch W1 is turned on, a current flows from the constant current source GA2 to the capacitor C1, and the voltage between the terminals of the capacitor C1 is increased. The reference voltage VREF according to the voltage generated between the terminals of the capacitor C1 is output from the operational amplifier PA1. In this case, the voltage between the terminals of the capacitor C1 can be given as the integration of the currents flowing from the constant current source GA2 to the capacitor C1, and therefore, the ramp wave can be obtained as the reference voltage VREF. By turning on the switch W1, the voltage between the terminals of the capacitor C1 can be zero, and the output of the operational amplifier PA1 can be reset.

On the other hand, the column ADC circuit 4 is provided with level comparison devices CP1 to CPn and time digital conversion devices TD1 to TDn for each column. The level comparison devices CP1 to CPn are connected to the pixels PC1 to PCn in the first column to the n-th column, respectively. The level comparison device CP1 is provided with capacitors C2, C3, a comparator PA2, switches W2, W3, and an inverter V1.

The inverse input terminal of the comparator PA2 is connected to the vertical signal line Vlin via the capacitor C2, and the non-inverse input terminal of the comparator PA2 is connected to the output terminal of the operational amplifier PAL A switch W2 is connected between the inverse input terminal and the output terminal of the comparator PA2. The input terminal of the inverter V1 is connected via the capacitor C3 to the output terminal of the comparator PA2, and the output terminal of the inverter V1 is connected to the time digital conversion device TD1. A switch W3 is connected between the inverse input terminal and the output terminal of the inverter V1. The delay time control voltage VD and the reference clock MCK are input into the time digital conversion device TD1.

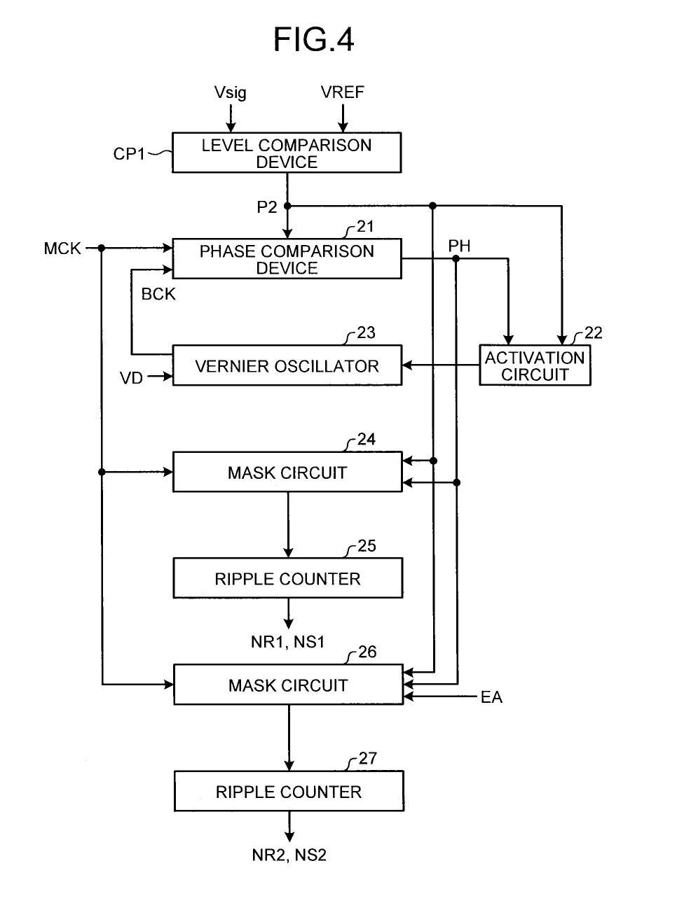

FIG. 4 is a block diagram illustrating an example of configuration of a time digital conversion device of FIG. 3.

In FIG. 4, time digital conversion device TD1 includes a phase comparison device 21, an activation circuit 22, a vernier oscillator 23, mask circuits 24, 26 and ripple counters 25, 27. The phase comparison device 21 compares the phases of the reference clock MCK and the vernier clock BCK. The activation circuit 22 controls activation and stop of the vernier oscillator 23 on the basis of the output P2 of the level comparison device CP1 and the output PH of the phase comparison device 21. The vernier oscillator 23 generates the vernier clock BCK on the basis of the delay time control voltage VD. After the reference voltage VREF attains the pixel signal that is read from the pixel PC, the mask circuit 24 allows the reference clock MCK to pass through until the phase relationship of the reference clock MCK and the vernier clock BCK is inversed. The ripple counter 25 counts the reference clock MCK that is passed through by the mask circuit 24. The mask circuit 26 allows the reference clock MCK to pass through, after the reference voltage VREF attains the pixel signal that is read from the pixel PC and after the phase relationship of the reference clock MCK and the vernier clock BCK is inversed. The ripple counter 27 counts the reference clock MCK that is passed through by the mask circuit 26.

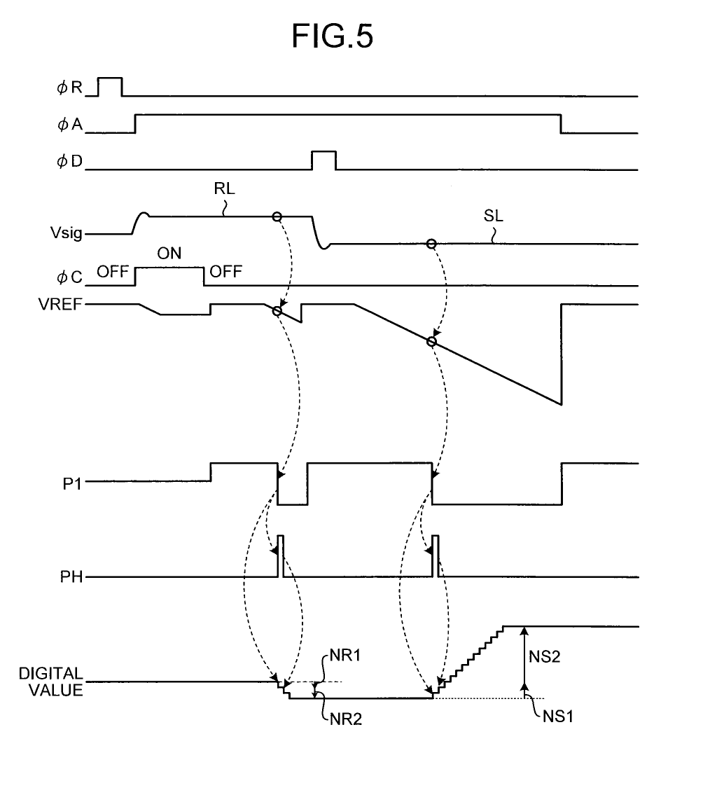

FIG. 5 is a timing chart illustrating a voltage waveform of each unit during reading operation of the pixel of FIG. 1.

In FIG. 5, when the row selection signal ΦA is at the low level, the row selection transistor Ta is in the OFF state, and does not perform the source follower operation, and therefore, no signal is output to the vertical signal line Vlin. At this occasion, when the reading signal ΦD and the reset signal ΦR are at high levels, the reading transistor Td and the reset transistor Tr are turned on. Then, the charges accumulated in the photodiode PD are discharged to the floating diffusion FD, and are discharged via the reset transistor Tr to the power supply potential VDD.

When the charges accumulated in the photodiode PD are discharged to the power supply potential VDD and thereafter the reading signal ΦD attains the low level, the photodiode PD starts accumulation of effective signal charges. Then, when the reset signal ΦR rises, the reset transistor Tr is turned on, and redundant charges generated by a leak current and the like are transferred to the floating diffusion FD.

Subsequently, when the row selection signal ΦA attains the high level, the row selection transistor Ta of the pixel PC is turned on, and the power supply potential VDD is applied to the drain of the amplification transistor Tb, whereby the source follower is constituted by the amplification transistor Tb and the constant current source GA1. Then, a voltage according to the reset level RL of the floating diffusion FD is applied to the gate of the amplification transistor Tb. In this case, the source follower is constituted by the amplification transistor Tb and the constant current source GA1, and therefore, the voltage of the vertical signal line Vlin follows the voltage applied to the gate of the amplification transistor Tb, and the pixel signal Vsig of the reset level RL is output via the vertical signal line Vlin to the column ADC circuit 4.

Then, while the pixel signal Vsig of the reset level RL is output to the vertical signal line Vlin, a reset pulse φC is applied to the switch W2, and when the switch W2 is turned on, the input voltage of the inverse input terminal of the comparator PA2 is clamped by the output voltage P1, and the operation point is set. At this occasion, the capacitor C2 holds charges according to the difference of the voltage from the pixel signal Vsig applied via the vertical signal line Vlin, and the input voltage of the comparator PA2 is set at zero. When the reset pulse φC is applied to the switch W3, and the switch W3 is turned on, the input voltage of the input terminal of the inverter V1 is clamped by the output voltage, and the operation point is set. At this occasion, the capacitor C3 holds charges according to the difference of the voltage from the output signal applied via the inverter V1, and the input voltage of the inverter V1 is set at zero.

After the switches W2, W3 are turned off, and the pixel signal Vsig of the reset level RL is input into the comparator PA2 via the capacitor C2, the ramp wave is given as the reference voltage VREF, and the pixel signal Vsig of the reset level RL and the reference voltage VREF are compared. Then, after the output voltage P1 of the comparator PA2 is inversed at the inverter V1, it is input into the time digital conversion device TD1.

Then, in the time digital conversion device TD1, when the level of the reference voltage VREF matches the pixel signal Vsig of the reset level RL, the output voltage P1 of the comparator PA2 falls, and the output voltage P1 is inversed at the inverter V1, whereby the output P2 of the level comparison device CP1 rises. When the output P2 of the level comparison device CP1 rises, the output PH of the phase comparison device 21 rises, and the reference clock MCK is input via the mask circuit 24 into the ripple counter 25, whereby the reference clock MCK is counted. When the output P2 of the level comparison device CP1 rises, the vernier oscillator 23 is activated via the activation circuit 22, and the vernier oscillator 23 generates a vernier clock BCK. Then, the phase comparison device 21 compares the phases of the reference clock MCK and the vernier clock BCK. Then, when the phases of the reference clock MCK and the vernier clock BCK are inversed, the output P2 of the level comparison device CP1 falls, and the input of the reference clock MCK into the ripple counter 25 is cut off by the mask circuit 24, and the first count value NR1 of the reset level RL is held by the ripple counter 25. When the output P2 of the level comparison device CP1 falls, the vernier oscillator 23 is stopped via the activation circuit 22. Further, when the output P2 of the level comparison device CP1 falls, the reference clock MCK is input via the mask circuit 26 into the ripple counter 27, whereby the reference clock MCK is counted. Then, when the AD conversion is finished, and the AD conversion finish signal EA falls, the input of the reference clock MCK into the ripple counter 27 is cut off by the mask circuit 26, and the second count value NR2 of the reset level RL is held by the ripple counter 27.

Then, the first count value NR1 and the second count value NR2 are sent to the calculation circuit 9, and on the basis of the first count value NR1 and the second count value NR2, the AD conversion value DR at the reset level of the pixel signal is calculated. When the cycle of the vernier clock BCK is denoted as HB, and the cycle of the reference clock MCK is denoted as HM, the AD conversion value DR can be calculated according to the following expression.

DR=NR2×HM/(HM−HB)+NR1

Subsequently, when the reading signal φD rises, the reading transistor Td is turned on, and the charges accumulated in the photodiode PD are transferred to the floating diffusion FD, and the voltage according to the signal level SL of the floating diffusion FD is applied to the gate of the amplification transistor Tb. In this case, the source follower is constituted by the amplification transistor Tb and the constant current source GA1, and therefore, the voltage of the vertical signal line Vlin follows the voltage applied to the gate of the amplification transistor Tb, and the pixel signal Vsig of the signal level SL is output via the vertical signal line Vlin to the column ADC circuit 4.

Then, in the column ADC circuit 4, while the pixel signal Vsig of the signal level SL is input via the capacitor C2 into the comparator PA2, the ramp wave is given as the reference voltage VREF, and the pixel signal Vsig of the signal level SL and the reference voltage VREF are compared. Then, after the output voltage P1 of the comparator PA2 is inversed at the inverter V1, it is input into the time digital conversion device TD1.

Then, in the time digital conversion device TD1, when the level of the reference voltage VREF matches the pixel signal Vsig of the signal level SL, the output voltage P1 of the comparator PA2 falls, and the output voltage P1 is inversed at the inverter V1, whereby the output P2 of the level comparison device CP1 rises. When the output P2 of the level comparison device CP1 rises, the output PH of the phase comparison device 21 rises, and the reference clock MCK is input via the mask circuit 24 into the ripple counter 25, whereby the reference clock MCK is counted. When the output P2 of the level comparison device CP1 rises, the vernier oscillator 23 is activated via the activation circuit 22, and the vernier oscillator 23 generates a vernier clock BCK. Then, the phase comparison device 21 compares the phases of the reference clock MCK and the vernier clock BCK. Then, when the phases of the reference clock MCK and the vernier clock BCK are inversed, the output P2 of the level comparison device CP1 falls, and the input of the reference clock MCK into the ripple counter 25 is cut off by the mask circuit 24, and the first count value NS1 of the signal level SL is held by the ripple counter 25. When the output P2 of the level comparison device CP1 falls, the vernier oscillator 23 is stopped via the activation circuit 22. Further, when the output P2 of the level comparison device CP1 falls, the reference clock MCK is input via the mask circuit 26 into the ripple counter 27, whereby the reference clock MCK is counted. Then, when the AD conversion is finished, and the AD conversion finish signal EA falls, the input of the reference clock MCK into the ripple counter 27 is cut off by the mask circuit 26, and the second count value NS2 of the signal level SL is held by the ripple counter 27.

Then, the first count value NS1 and the second count value NS2 are sent to the calculation circuit 9, and on the basis of the first count value NS1 and the second count value NS2, the AD conversion value DS at the signal level of the pixel signal is calculated. The AD conversion value DS can be calculated according to the following expression.

DS=NS2×HM/(HM−HB)+NS1

Then, a difference DR−DS between the AD conversion value DR of the reset level RL and the AD conversion value DS of the signal level SL is calculated, and is output as the output signal S1.

In this case, only during the count operation of the first count values NR1, NS1, the vernier oscillator 23 is operated, so that the power consumption of the vernier oscillator 23 can be reduced.

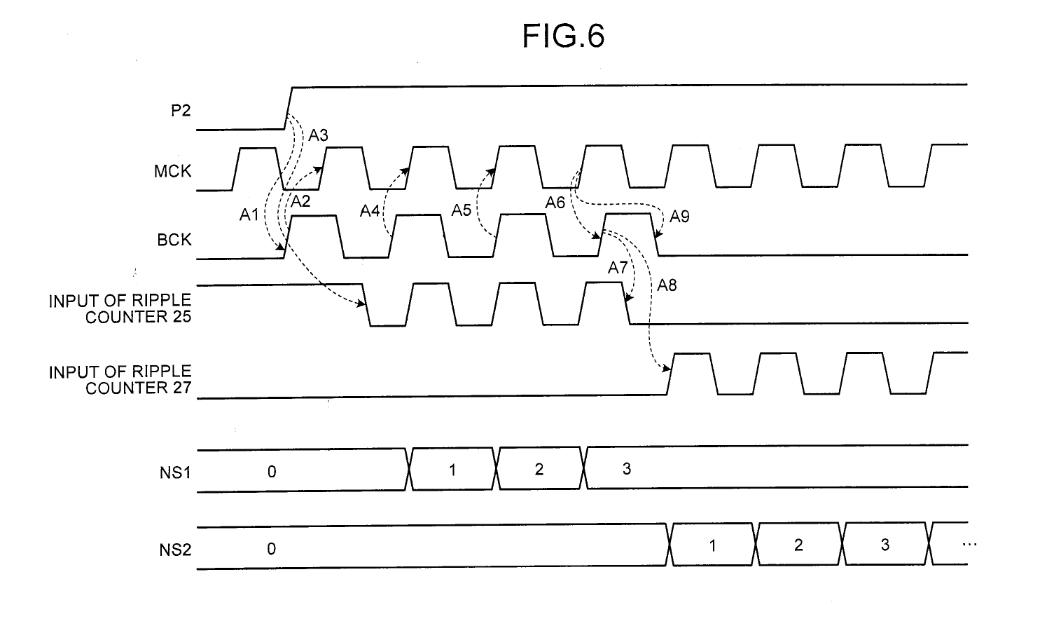

FIG. 6 is a timing chart illustrating operation of the time digital conversion device of FIG. 4. In FIG. 6, for example, the first count value NS1 and the second count value NS2 are calculated.

In FIG. 6, when the level of the reference voltage VREF matches the pixel signal Vsig of the signal level RL, the output P2 of the level comparison device CP1 rises. When the output P2 of the level comparison device CP1 rises, the vernier oscillator 23 is activated via the activation circuit 22 (A1), and the vernier oscillator 23 generates a vernier clock BCK. Then, the phase comparison device 21 compares the phases of the reference clock MCK and the vernier clock BCK (A2, A4, A5, A6). When the output P2 of the level comparison device CP1 rises, the reference clock MCK is input via the mask circuit 24 into the ripple counter 25, whereby the reference clock MCK is counted (A3). Then, when the phases of the reference clock MCK and the vernier clock BCK are inversed (A6), the input of the reference clock MCK into the ripple counter 25 is cut off by the mask circuit 24 (A7), and the first count value NS1 of the signal level is held by the ripple counter 25. When the phases of the reference clock MCK and the vernier clock BCK are inversed (A6), the reference clock MCK is input via the mask circuit 26 into the ripple counter 27, whereby the reference clock MCK is counted (A8). Further, the phases of the reference clock MCK and the vernier clock BCK are inversed (A6), the vernier oscillator 23 is stopped via the activation circuit 22 (A9).

In this case, on the basis of the phase relationship of the vernier clock BCK and the reference clock MCK, the count period of the reference clock MCK is controlled, whereby the time resolution of the count value can be improved without increasing the clock frequency.

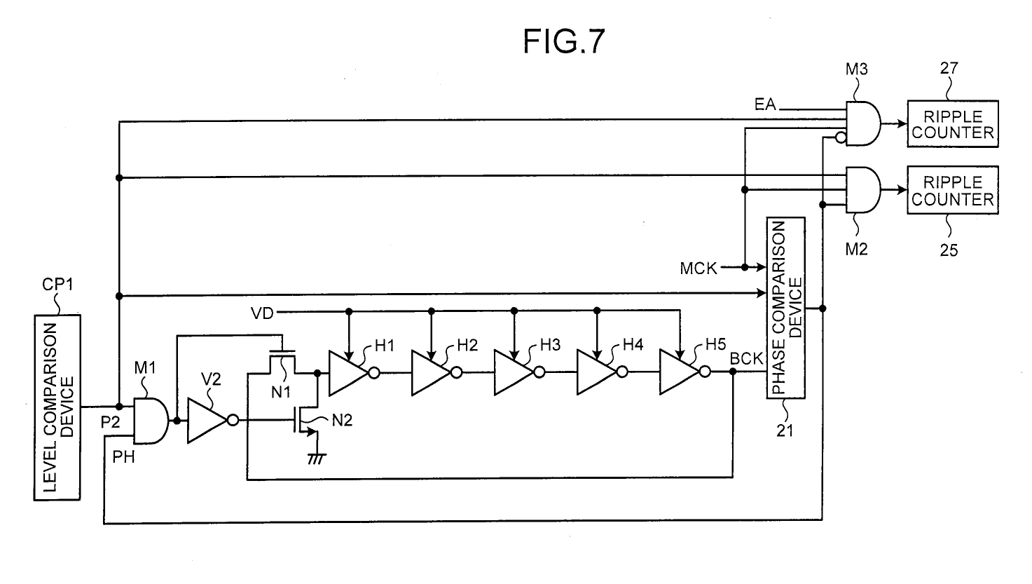

FIG. 7 is a circuit diagram illustrating an example of configuration of the activation circuit 22, the vernier oscillator 23, and the mask circuits 24, 26 of FIG. 4.

In FIG. 7, the activation circuit 22 is provided with an AND circuit M1, the mask circuit 24 is provided with an AND circuit M2, and the mask circuit 26 is provided with an AND circuit M3. The vernier oscillator 23 includes delay devices H1 to H5, an inverter V2 and N-type transistors N1, N2.

The delay devices H1 to H5 are connected in series, and the output terminal of the delay device H5 is connected via the N-type transistor N1 to the input terminal of the delay device H1. The input terminal of the delay device H1 is connected to the N-type transistor N2. The input terminal of the inverter V2 is connected to the gate of the N-type transistor N1, and the output terminal of the inverter V2 is connected to the gate of the N-type transistor N2. The input terminal of the inverter V2 is connected to the output terminal of the AND circuit M1.

The output P2 of the level comparison device CP1 and the output PH of the phase comparison device 21 are input into the AND circuit M1. The output P2 of the level comparison device CP1, the output PH of the phase comparison device 21, and the reference clock MCK are input into the AND circuit M2. The output P2 of the level comparison device CP1, AD conversion finish signal EA, and the reference clock MCK are input into the AND circuit M3, and the output PH of the phase comparison device 21 is inversed and input thereinto.

Then, when the output P2 of the level comparison device CP1 rises, the output PH of the phase comparison device 21 rises, and the output of the AND circuit M1 rises. Accordingly, the N-type transistor N1 is turned on, and the N-type transistor N2 is turned off, and the delay devices H1 to H5 constitute a ring oscillator, so that a vernier clock BCK is generated. The reference clock MCK is input via the AND circuit M2 into the ripple counter 25, whereby the reference clock MCK is counted.

The phase comparison device 21 compares the phases of the reference clock MCK and the vernier clock BCK. Then, when the phases of the reference clock MCK and the vernier clock BCK are inversed, the output P2 of the level comparison device CP1 falls. Accordingly, the input of the reference clock MCK into the ripple counter 25 is cut off by the AND circuit M2. When the output P2 of the level comparison device CP1 falls, the output of the AND circuit M1 rises. Accordingly, the N-type transistor N1 is turned off, and the N-type transistor N2 is turned on, and the delay devices H1, H5 are isolated, so that this stops generation of the vernier clock BCK. Further, when the output P2 of the level comparison device CP1 falls, the reference clock MCK is input via the AND circuit M3 into the ripple counter 27, whereby the reference clock MCK is counted. Then, when the AD conversion is finished, and the AD conversion finish signal EA falls, the input of the reference clock MCK into the ripple counter 27 is cut off by the AND circuit M3.

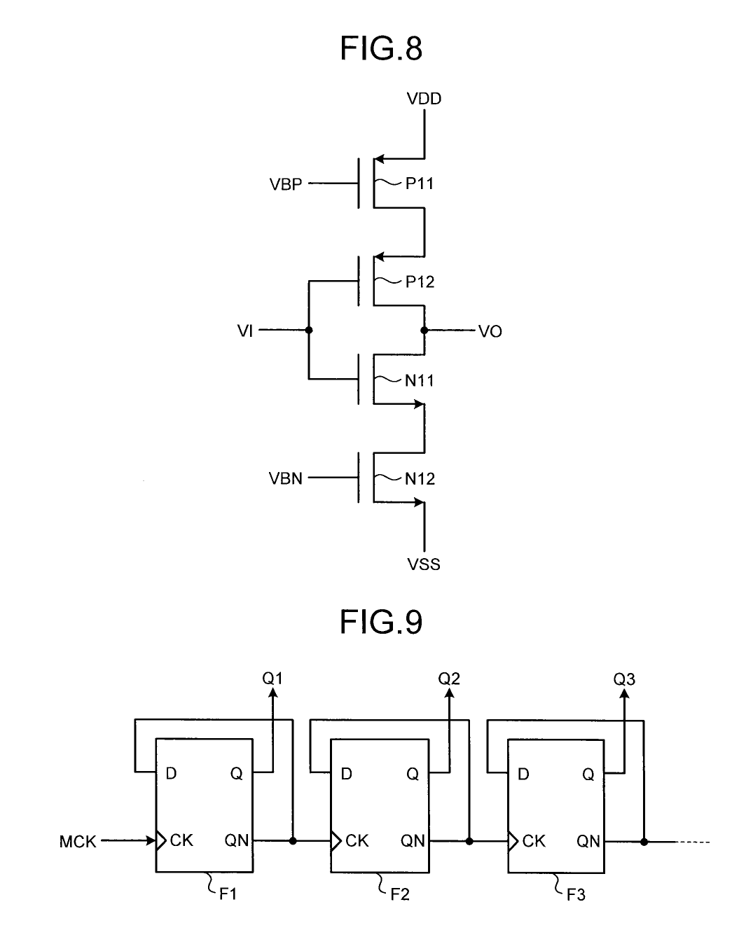

FIG. 8 is a circuit diagram illustrating an example of configuration of delay devices H1 to H5 of FIG. 7.

In FIG. 8, for example, the delay device H1 includes P-type transistors P11, P12 and N-type transistors N11, N12. The P-type transistors P11, P12 and the N-type transistors N11, N12 are connected in series. The source of the P-type transistor P11 is connected to the first potential VDD, and the source of the N-type transistor N12 is connected to the second potential VSS. The first potential VDD can be set higher than the second potential VSS, and, for example, the first potential VDD can be set as the power supply potential, and the second potential VSS can be set as the ground potential. The input voltage V1 is input into the gate of the P-type transistor P12 and the gate of the N-type transistor N11, and the output voltage VO is output from the drain of the P-type transistor P12. The bias voltage VBP is input into the gate of the P-type transistor P11, and the bias voltage VBN is input into the gate of the N-type transistor N12. In this case, when the bias voltage VBP or the bias voltage VBN is increased, the load of the delay device H1 can be lightened, and the delay time of the output voltage VO with respect to the input voltage V1 can be reduced. Accordingly, by using the bias voltage VBP or the bias voltage VBN as the delay time control voltage VD, the cycle of the vernier clock BCK can be controlled.

FIG. 9 is a circuit diagram illustrating an example of configuration of ripple counters 25, 27 of FIG. 4.

In FIG. 9, for example, the ripple counter 25 includes flip-flops F1 to F3. In this case, the flip-flops F1 to F3 include an input terminal D, a clock terminal CK, an output terminal Q, and an inverse output terminal QN. The flip-flops F1 to F3 are connected in series. The reference clock MCK is input into the clock terminal CK of the flip-flop F1. The inverse output terminal Q of the flip-flops F1 to F3 in the previous stage is connected to the clock terminal CK of the flip-flops F1 to F3 in the subsequent stage. The inverse output terminal QN of the flip-flops F1 to F3 in the stage in question is connected to the input terminal D of the flip-flops F1 to F3 in the stage in question.

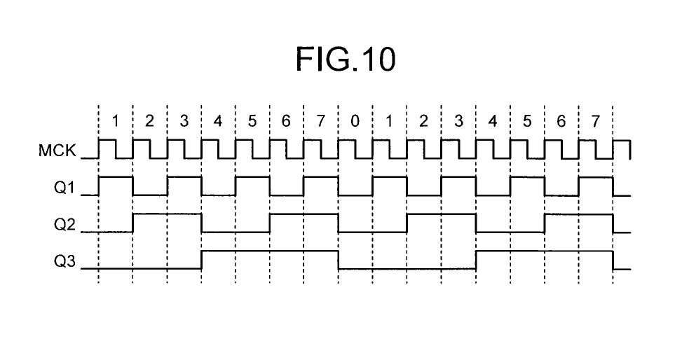

FIG. 10 is a timing chart illustrating operation of the ripple counters 25, 27 of FIG. 9.

In FIG. 10, clock signals Q1, Q2, Q3 are output from the output terminals Q of the flip-flops F1 to F3, respectively. In this case, when two reference clocks MCK are input, one clock signal Q1 is output. When two clock signals Q1 are input, one clock signal Q2 is output. When two clock signals Q2 are input, one clock signal Q3 is output. Accordingly, the clock signals Q1, Q2, Q3 can represent digital values according to the number of reference clocks MCK.

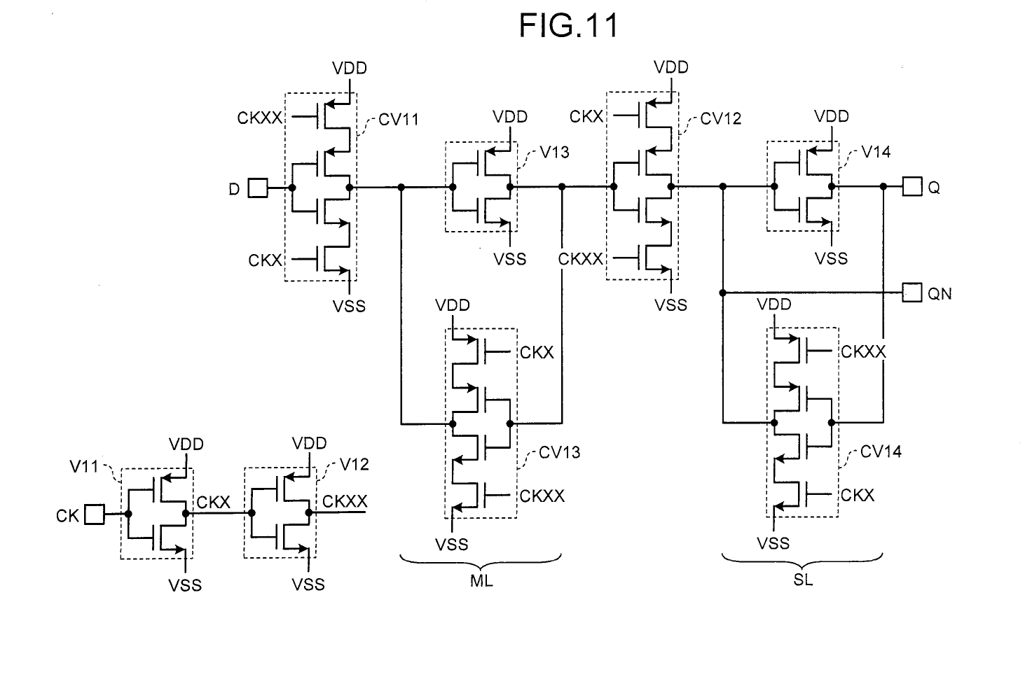

FIG. 11 is a circuit diagram illustrating an example of configuration of flip-flops F1 to F3 of FIG. 9.

In FIG. 11, for example, the flip-flop F1 includes inverters V11 to V14 and clocked inverters CV11 to CV14. The inverters V11, V12 are connected in series. The clocked inverter CV11, the inverter V13, the clocked inverter CV12, and the inverter V14 are connected successively in series. The inverter V13 is connected with the clocked inverter CV13 in an inverse parallel manner. The inverter V14 is connected with the clocked inverter CV14 in an inverse parallel manner. The inverter V13 and the clocked inverter CV13 can constitute a slave latch SL. The inverter V14 and the clocked inverter CV14 can constitute a master latch ML.

In this case, the input terminal of the inverter V11 corresponds to the clock terminal CK. The input terminal of the clocked inverter CV11 corresponds to the input terminal D. The input terminal of the inverter V14 corresponds to the inverse output terminal QN. The output terminal of the inverter V14 corresponds to the output terminal Q. An inverse clock CKX is output from the inverter V11, and a non-inverse clock CKXX is output from the inverter V12. The inverse clock CKX is input into the inverse clock terminals of the clocked inverters CV11, CV14 and the non-inverse clock terminals of the clocked inverters CV12, CV13. The non-inverse clock CKXX is input into the non-inverse clock terminals of the clocked inverters CV11, CV14 and the inverse clock terminals of the clocked inverters CV12, CV13.

Then, when the potential of the clock terminal CK falls when data are input into the input terminal D, the data are input via the clocked inverter CV11 into the inverter V13, and input via the inverter V13 into the clocked inverters CV12, CV13.

Subsequently, when the clock signal CK rises, data are returned back via the clocked inverter CV13 to the input terminal of the inverter V13, and held by the master latch ML. Data are input via the clocked inverter CV12 into the inverter V14, and output via the output terminal Q and the inverse output terminal QN. Subsequently, when the clock signal CK falls, data are returned back via the clocked inverter CV14 to the input terminal of the inverter V14, and held by the slave latch SL.

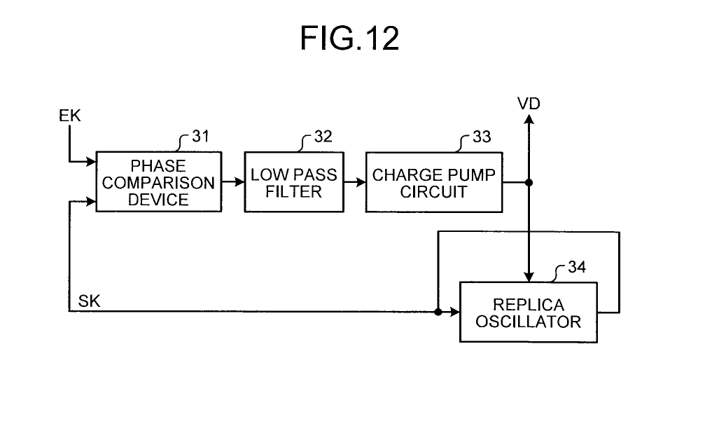

FIG. 12 is a block diagram illustrating an example of configuration of a delay time control circuit of FIG. 1.

In FIG. 12, the delay time control circuit 8 includes a phase comparison device 31, a low pass filter 32, a charge pump circuit 33, and a replica oscillator 34. It should be noted that the replica oscillator 34 can emulate operation of the vernier oscillator 23 of FIG. 7. In this case, the replica oscillator 34 can adjust the oscillation frequency by changing the number of inverters H1 to H5.

Then, the phase comparison device 31 compares the phases between an external clock EK and a replica clock SK generated by the replica oscillator 34, and the comparison result is input via the low pass filter 32 into the charge pump circuit 33. Then, the charge pump circuit 33 controls the delay time control voltage VD so that the phases of the replica clock SK and external clock EK become the same.

### Second Embodiment

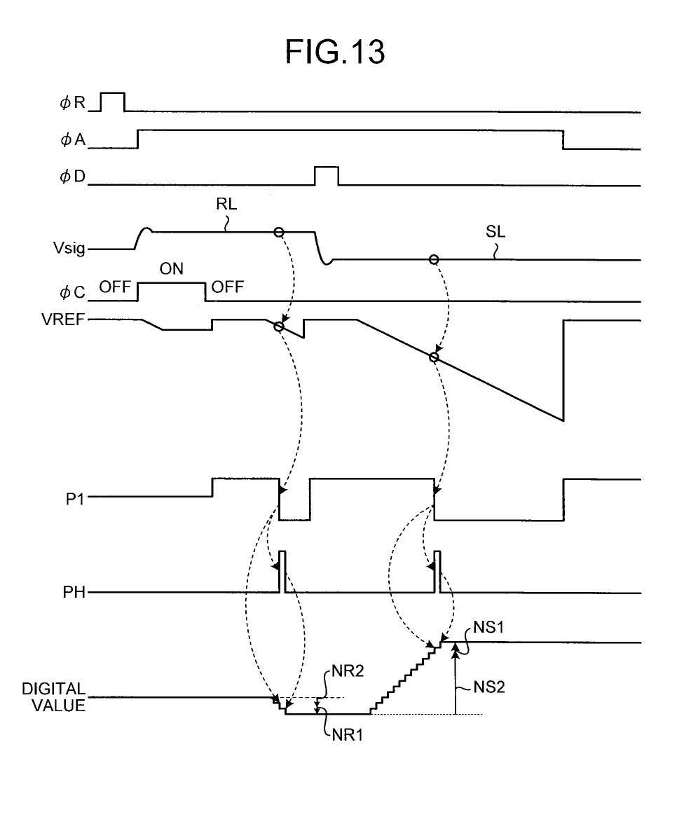

FIG. 13 is a timing chart illustrating a voltage waveform of each unit during reading operation of the pixel with a solid-state imaging device according to a second embodiment

In FIG. 13, while the pixel signal Vsig of the reset level RL is input into the comparator PA2 via the capacitor C2, the ramp wave is given as the reference voltage VREF, and the pixel signal Vsig of the reset level RL and the reference voltage VREF are compared. Then, after the output voltage P1 of the comparator PA2 is inversed at the inverter V1, it is input into the time digital conversion device TD1 of FIG. 3.

In the time digital conversion device TD1, the reference clock MCK is input via the mask circuit 26 into the ripple counter 27, whereby the reference clock MCK is counted. Then, the reference clock MCK is counted until the level of the reference voltage VREF becomes the same as the pixel signal Vsig of the reset level RL, whereby the second count value NR2 of the reset level RL is calculated and held by the ripple counter 27. At this occasion, when the level of the reference voltage VREF matches the pixel signal Vsig of the reset level RL, the output voltage P1 of the comparator PA2 falls, and the output voltage P1 is inversed at the inverter V1, whereby the output P2 of the level comparison device CP1 rises. When the output P2 of the level comparison device CP1 rises, the input of the reference clock MCK into the ripple counter 27 is cut off by the mask circuit 26.

When the output P2 of the level comparison device CP1 rises, the reference clock MCK is input via the mask circuit 24 into the ripple counter 25, whereby the reference clock MCK is counted. When the output P2 of the level comparison device CP1 rises, the vernier oscillator 23 is activated via the activation circuit 22, and the vernier oscillator 23 generates a vernier clock BCK. When the output P2 of the level comparison device CP1 rises, the output PH of the phase comparison device 21 rises. Then, the phase comparison device 21 compares the phases of the reference clock MCK and the vernier clock BCK. Then, when the phases of the reference clock MCK and the vernier clock BCK are inversed, the output PH of the phase comparison device 21 falls, and the input of the reference clock MCK into the ripple counter 25 is cut off by the mask circuit 24, and the first count value NR1 of the reset level is held by the ripple counter 25. When the output PH of the phase comparison device 21 falls, the vernier oscillator 23 is stopped via the activation circuit 22.

While the pixel signal Vsig of the signal level SL is input via the capacitor C2 into the comparator PA2, the ramp wave is given as the reference voltage VREF, and the pixel signal Vsig of the signal level SL and the reference voltage VREF are compared. Then, after the output voltage P1 of the comparator PA2 is inversed at the inverter V1, it is input into the time digital conversion device TD1 of FIG. 3.

In the time digital conversion device TD1, the reference clock MCK is input via the mask circuit 26 into the ripple counter 27, whereby the reference clock MCK is counted. Then, the reference clock MCK is counted until the level of the reference voltage VREF becomes the same as the pixel signal Vsig of the signal level SL, whereby the second count value NS2 of the signal level SL is calculated and held by the ripple counter 27. At this occasion, when the level of the reference voltage VREF matches the pixel signal Vsig of the signal level SL, the output voltage P1 of the comparator PA2 falls, and the output voltage P1 is inversed at the inverter V1, whereby the output P2 of the level comparison device CP1 rises. When the output P2 of the level comparison device CP1 rises, the input of the reference clock MCK into the ripple counter 27 is cut off by the mask circuit 26.

When the output P2 of the level comparison device CP1 rises, the reference clock MCK is input via the mask circuit 24 into the ripple counter 25, whereby the reference clock MCK is counted. When the output P2 of the level comparison device CP1 rises, the vernier oscillator 23 is activated via the activation circuit 22, and the vernier oscillator 23 generates a vernier clock BCK. When the output P2 of the level comparison device CP1 rises, the output PH of the phase comparison device 21 rises. Then, the phase comparison device 21 compares the phases of the reference clock MCK and the vernier clock BCK. Then, when the phases of the reference clock MCK and the vernier clock BCK are inversed, the output PH of the phase comparison device 21 falls, and the input of the reference clock MCK into the ripple counter 25 is cut off by the mask circuit 24, and the first count value NS1 of the signal level SL is held by the ripple counter 25. When the output PH of the phase comparison device 21 falls, the vernier oscillator 23 is stopped via the activation circuit 22.

In this case, only during the count operation of the first count values NR1, NS1, the vernier oscillator 23 is operated, so that the power consumption of the vernier oscillator 23 can be reduced.

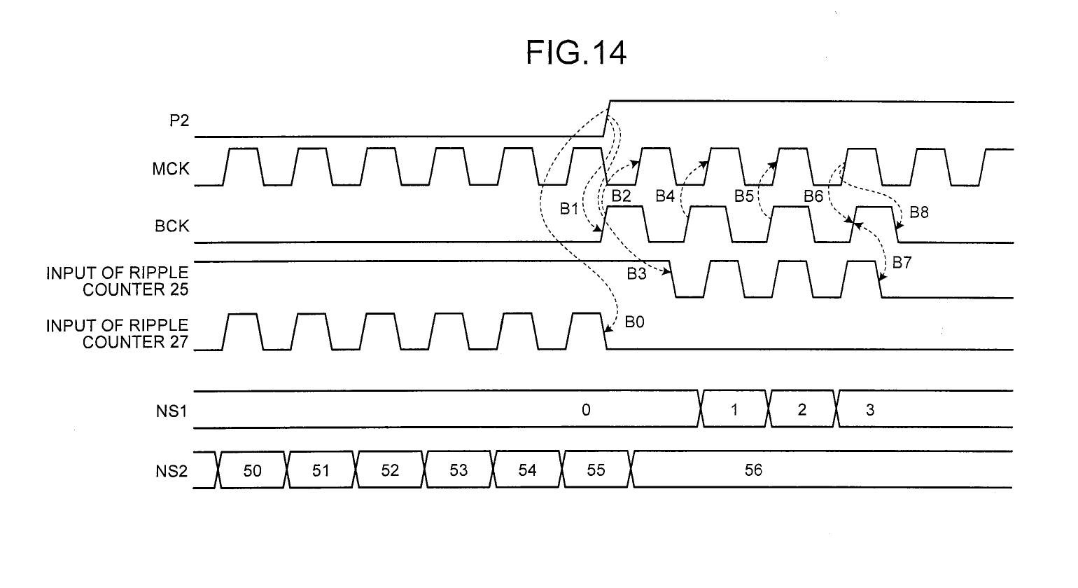

FIG. 14 is a timing chart illustrating operation of a time digital conversion device in the solid-state imaging device according to the second embodiment. In FIG. 14, for example, the first count value NS1 and the second count value NS2 are calculated.

In FIG. 14, while the pixel signal Vsig of the signal level SL is input into the comparator PA2 via the capacitor C2, the ramp wave is given as the reference voltage VREF, and in this case, the reference clock MCK is input via the mask circuit 26 into the ripple counter 27, whereby the reference clock MCK is counted. Then, the reference clock MCK is counted until the level of the reference voltage VREF becomes the same as the pixel signal Vsig of the signal level SL, whereby the second count value NS2 of the signal level SL is calculated and held by the ripple counter 27. At this occasion, when the level of the reference voltage VREF matches the pixel signal Vsig of the signal level SL, the output P2 of the level comparison device CP1 rises, and the input of the reference clock MCK into the ripple counter 27 is cut off by the mask circuit 26 (B0).

When the output P2 of the level comparison device CP1 rises, the vernier oscillator 23 is activated via the activation circuit 22, and the vernier oscillator 23 generates a vernier clock BCK (B1). When the output P2 of the level comparison device CP1 rises, the reference clock MCK is input via the mask circuit 24 into the ripple counter 25, whereby the reference clock MCK is counted (B3). When the output P2 of the level comparison device CP1 rises, the phases of the reference clock MCK and the vernier clock BCK are compared by the phase comparison device 21 (B2, B4, B5, B6). Then, when the phases of the reference clock MCK and the vernier clock BCK are inversed (B6), the input of the reference clock MCK into the ripple counter 25 is cut off by the mask circuit 24 (B7), and the first count value NS1 of the signal level SL is held by the ripple counter 25. Further, the phases of the reference clock MCK and the vernier clock BCK are inversed (B6), the vernier oscillator 23 is stopped via the activation circuit 22 (B8).

In this case, on the basis of the phase relationship of the vernier clock BCK and the reference clock MCK, the count period of the reference clock MCK is controlled, whereby the time resolution of the count value can be improved without increasing the clock frequency.

The vernier clock BCK and reference clock MCK may be received from the outside, or may be generated in the solid-state imaging device. To generate the vernier clock BCK and the reference clock MCK, a PLL (Phase Locked Loop) circuit may be used, or a DLL (Delay Locked Loop) circuit may be used. A gray code counter may be used as a counter for counting the reference clock MCK.

### Third Embodiment

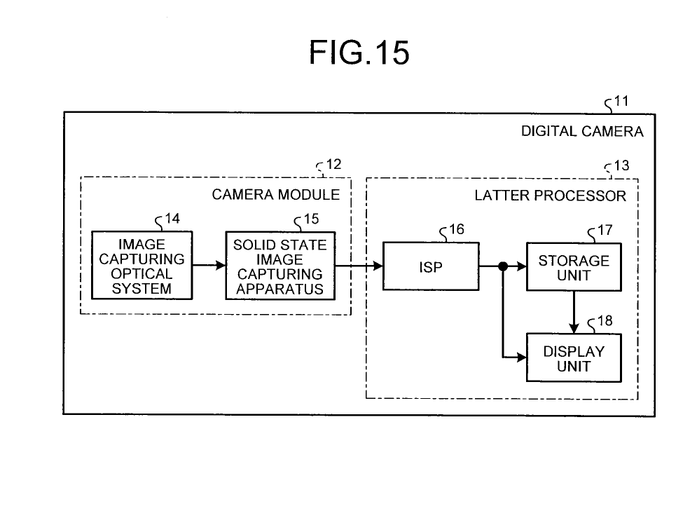

FIG. 15 is a block diagram illustrating a schematic configuration of a digital camera to which a solid-state imaging device according to a third embodiment is applied.

In FIG. 15, a digital camera 11 includes a camera module 12 and a latter processor 13. The camera module 12 includes imaging optical system 14 and a solid state image capturing device 15. The latter processor 13 includes an image signal processor (ISP) 16, a storage unit 17, and a display unit 18. The solid-state imaging device 15 may employ the configuration of FIG. 1. At least a part of configuration of the ISP 16 may be made into a single chip together with the solid-state imaging device 15.

The imaging optical system 14 receives light from a subject and forms a subject image. The solid state image capturing device 15 images the subject image. The ISP 16 performs signal processing on an image signal obtained by the imaging by the solid state image capturing device 15. The storage unit 17 stores the image that has undergone the signal processing at the ISP 16. The storage unit 17 outputs the image signal to the display unit 18 in conformity with a user operation or the like. The display unit 18 displays the image in conformity with the image signal received from the ISP 16 or the storage unit 17. The display unit 18 is, for example, a liquid crystal display. The camera module 12 is applied to, besides the digital camera 11, electronic equipment such as a portable terminal with an incorporated camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit in which pixels accumulating photoelectric converted charges are arranged in a matrix form;
a column ADC circuit configured to refer to a comparison result between a reference voltage and a pixel signal that is read from the pixel, and perform count operation on the basis of phase relationship between a first clock and a second clock of which cycle is different from that of the first clock; and
a calculation circuit configured to calculate an AD conversion value of the pixel signal on the basis of a count result provided by the column ADC circuit.

2. The solid-state imaging device according to claim 1, wherein a upper bit of the AD conversion value is calculated on the basis of a comparison result of the reference voltage and the pixel signal that is read from the pixel, and a lower bit of the AD conversion value is calculated on the basis of a phase relationship between the first clock and the second clock.

3. The solid-state imaging device according to claim 1, wherein after the reference voltage attains the pixel signal that is read from the pixel, the column ADC circuit calculates a first count value that is counted until the phase relationship of the first clock and the second clock is inversed, and a second count value that is counted after the phase relationship of the first clock and the second clock is inversed.

4. The solid-state imaging device according to claim 3, wherein the column ADC circuit comprises:
a level comparison device configured to compare the reference voltage and the pixel signal that is read from the pixel;
a vernier oscillator configured to generate the second clock;
a phase comparison device configured to compare phases of the first clock and the second clock;
a first mask circuit configured to allow the first clock to pass through until phase relationship of the first clock and the second clock is inversed after the reference voltage attains the pixel signal that is read from the pixel;
a first counter circuit configured to count the first clock that is passed by the first mask circuit;
a second mask circuit configured to allow the first clock to pass through after the phase relationship of the first clock and the second clock is inversed, and after the reference voltage attains the pixel signal that is read from the pixel; and
a second counter circuit configured to count the first clock that is passed by the second mask circuit.

5. The solid-state imaging device according to claim 4 comprising an activation circuit, wherein after the reference voltage attains the pixel signal that is read from the pixel, the activation circuit activates the vernier oscillator, and after the phase relationship of the first clock and the second clock is inversed, the activation circuit stops the vernier oscillator.

6. The solid-state imaging device according to claim 4 comprising a delay time control circuit configured to control the cycle of the second clock.

7. The solid-state imaging device according to claim 6, wherein the vernier oscillator is a ring oscillator constituted by a delay device.

8. The solid-state imaging device according to claim 7, wherein the delay time control circuit controls delay time of the delay device, thus controlling the cycle of the second clock.

9. The solid-state imaging device according to claim 3, wherein the first count value is used as a vernier of the second count value.

10. The solid-state imaging device according to claim 2, wherein the cycle of the second clock is set so that the cycle of the first clock is divided on the basis of variation of the phase difference from the first clock for each cycle of the second clock.

11. The solid-state imaging device according to claim 1, wherein the column ADC circuit calculates a first count value that is counted until the phase relationship of the first clock and the second clock is inversed after the reference voltage attains the pixel signal that is read from the pixel, and a second count value that is counted until the reference voltage attains the pixel signal that is read from the pixel.

12. The solid-state imaging device according to claim 11, wherein the column ADC circuit comprises:
a level comparison device configured to compare the reference voltage and the pixel signal that is read from the pixel;
a vernier oscillator configured to generate the second clock;
a phase comparison device configured to compare phases of the first clock and the second clock;
a first mask circuit configured to allow the first clock to pass through until the reference voltage attains the pixel signal that is read from the pixel;
a first counter circuit configured to count the first clock that is passed by the first mask circuit;
a second mask circuit configured to allow the first clock to pass through until the phase relationship of the first clock and the second clock is inversed after the reference voltage attains the pixel signal that is read from the pixel; and
a second counter circuit configured to count the first clock that is passed by the second mask circuit.

13. The solid-state imaging device according to claim 12 comprising an activation circuit, wherein after the reference voltage attains the pixel signal that is read from the pixel, the activation circuit activates the vernier oscillator, and after the phase relationship of the first clock and the second clock is inversed, the activation circuit stops the vernier oscillator.

14. The solid-state imaging device according to claim 12 comprising a delay time control circuit configured to control the cycle of the second clock.

15. The solid-state imaging device according to claim 14, wherein the vernier oscillator is a ring oscillator constituted by a delay device.

16. The solid-state imaging device according to claim 15, wherein the delay time control circuit controls delay time of the delay device, thus controlling the cycle of the second clock.

17. The solid-state imaging device according to claim 11, wherein the first count value is used as a vernier of the second count value.

18. The solid-state imaging device according to claim 1, comprising:
a vertical scanning circuit configured to scan the pixels in a vertical direction;
a load circuit configured to perform source follower operation with the pixel, thus reading the pixel signal for each column from the pixel to a vertical signal line; and
a horizontal scanning circuit configured to scan the pixels in a horizontal direction.

19. The solid-state imaging device according to claim 1, wherein the pixel comprises:
a photodiode configured to perform photoelectric conversion;
a row selection transistor configured to perform row selection of the pixel;
a reading transistor configured to transfer a signal from the photodiode to a floating diffusion;
a reset transistor configured to reset a signal accumulated in the floating diffusion; and
an amplification transistor configured to detect potential of the floating diffusion.
